(19) United States
(12) Patent Application Publication
(10) Pub. No.: US 2012/0288488 A1
(43) Pub. Date: Nov. 15, 2012

(54) Compositions and Methods of Use for Livestock Pen Spray

(75) Inventors: Burt R. Sookram, Palm Harbor, FL (US); John W. Veenstra, Frisco, TX (US)

(73) Assignee: NOBLE ION, LLC, Frisco, TX (US)

(21) Appl. No.: 13/346,515

(22) Filed: Jan. 9, 2012

Related U.S. Application Data
(60) Provisional application No. 61/431,032, filed on Jan. 9, 2011.

(51) Int. Cl. A01N 43/40; A01N 59/20; A01N 59/16; A01N 59/00; A01N 37/06; A01N 37/02; A01N 37/10; A01N 55/08; A01N 37/44; A01N 43/16; A01N 43/26; A01N 59/26; A01N 59/10; A01N 37/40; A01N 63/00; A01P 1/00; A01P 5/00; A01N 33/12

(52) U.S. Cl. 424/94.61; 514/358; 514/643; 424/630; 424/618; 424/600; 424/662; 424/661; 424/718; 514/557; 514/574; 514/570; 514/64; 514/558; 514/569; 514/567; 514/453; 514/440; 424/605; 424/674; 424/673; 514/165; 424/94.66; 424/94.65

(57) ABSTRACT

Compositions and methods for preventing or controlling bacteria, viruses and parasitic growths that cause diarrhea, pneumonia and septicemia in animals comprising a biocidal system comprised of a primary biocide and a pH buffer component; a cationic or ionic surfactant having an HLB of from about 5 to about 30; a thickening agent; and an aqueous based carrier.

### RELATED U.S. APPLICATIONS

This application claims priority to U.S. Provisional Application No. 61/431,032 filed Jan. 9, 2011, the entire disclosure of which is incorporated herein by reference. U.S. patent application Ser. No. 13/295,882 entitled “Compositions for Treating Mastitis,” which is incorporated by reference herein in its entirety, and a U.S. patent application entitled “Compositions and Method of Use for Treating Lameness in Hoofed Domesticated Animals Due to Hairy Foot Warts and Foot Rot,” which is also incorporated by reference herein it its entirety, filed contemporaneously with this application.

### FIELD OF THE INVENTION

The present disclosure relates to compositions and methods of use that are effective in controlling or in preventing bacteria, viruses and parasitic growths that cause diarrhea, pneumonia and septicemia in livestock such as cattle, horses, pigs, goats, and poultry. More specifically, the invention pertains to compositions for cleaning livestock pens to eliminate bacteria, viruses and parasitic growths, and methods for applying those compositions. The inventive composition includes a primary biocide and a pH buffer component.

### BACKGROUND OF THE INVENTION

Even in a reasonably clean farm environment, all forms of livestock are exposed to bacteria, viruses, and parasites that may cause disease and sickness. While sick or diseased animals can be treated using, for example, digested antibiotics and topical creams, this increases the time and expense of raising the livestock. Animals can be prophylactically treated with antibiotics, however, this too increases the expense of raising the livestock, and broad use of preventative antibiotics may be restricted by law or discouraged by the marketplace.

One way of controlling disease and sickness in livestock is to eliminate the microorganisms that cause the disease and sickness. These microorganisms may come from a variety of sources, including feces, water, feeding utensils, rodents, birds, pets, and even people. If the source of infection can be identified, it can limited by physically modifying the conditions of the pen environment through improved ventilation, reduced crowding, more frequent bedding changes, and the like. However, since microorganisms are not visible to the naked eye, a pen area that appears to be sanitary may in fact be contaminated with harmful microorganisms.

In order to eliminate these harmful microorganisms from the pen environment, livestock producers may treat the pens with disinfectants that will eliminate these microorganisms. However, disinfectants that are harsh enough to render the environment inhospitable for these microorganisms may also render the environment inhospitable for the livestock. As such, a successful disinfection program may involve removing the animal from the pen, application of the disinfectant, rinsing away the disinfectant, and then returning the animal to the pen. Not only is this a labor-intensive and time-consuming process, it may not be entirely effective. Harmful microorganisms may still be present on the body of an otherwise healthy animal, and so returning the animal to the pen may reintroduce the harmful microorganisms to the pen.

As an alternative to application of a strong disinfectant, the livestock producer may use a milder disinfectant that won't harm the livestock, however, because by definition these disinfectants are milder, successful disinfection of the pen requires a higher volume of disinfectant and longer application times, a process which again is labor-intensive and time-consuming.

What is needed, therefore, is a composition that can eliminate disease-causing microorganisms from the pen environment without harm or discomfort to the livestock and without resort to labor-intensive and time-consuming processes.

### SUMMARY OF THE INVENTION

The disclosed compositions and methods relate to compositions that are effective in controlling or in preventing bacteria, viruses and parasitic growths that cause a variety of sickness and disease in livestock.

Accordingly, a primary object of the invention is providing compositions effective in killing one or more common bacterial pathogens, non-limiting examples of which include Salmonella, Pseudomonas aeruginosa, Staphylococcus aureus, Staphylococcus epidermidis, Streptococcus agalactiae, Mycoplasma, Escherichia coli, (E. coli) and Klebsiella pneumoniae.

A further object of the invention is providing compositions effective in killing one or more respiratory bacterial pathogens, non-limiting examples of which include Pasteurella multocida, Mannheimia (formerly Pasteurella) hemolytica, Haemophilus somnus and Mycoplasma.

An additional object of the invention is providing compositions effective in killing one or more viral pathogens, non-limiting examples of which include parainfluenza, cryptosporidium parvum for Rota & Corona virus, infectious' bovine rhinotracheitis (IBR), bovine viral diarrhea virus (BVDV) and, less commonly, bovine respiratory syncytial virus (BRSV).

Further, an additional object of the invention is providing compositions effective in killing one or more internal parasites include protozoans such as coccidiosis and cryptosporidiosis, nematodes (worms) infections, Liver flukes (Trematodes) and tapeworms (Cestodes), Lung worms. The stomach worms of major significance in cattle, Ostertagia ostertagi, Trichostrongylus axei, and Haemonchus spp., tend to be the most pathogenic of the gastrointestinal parasites.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### SUMMARY OF THE FIGURES

FIG. 1, is a photograph depicting newly born calf.

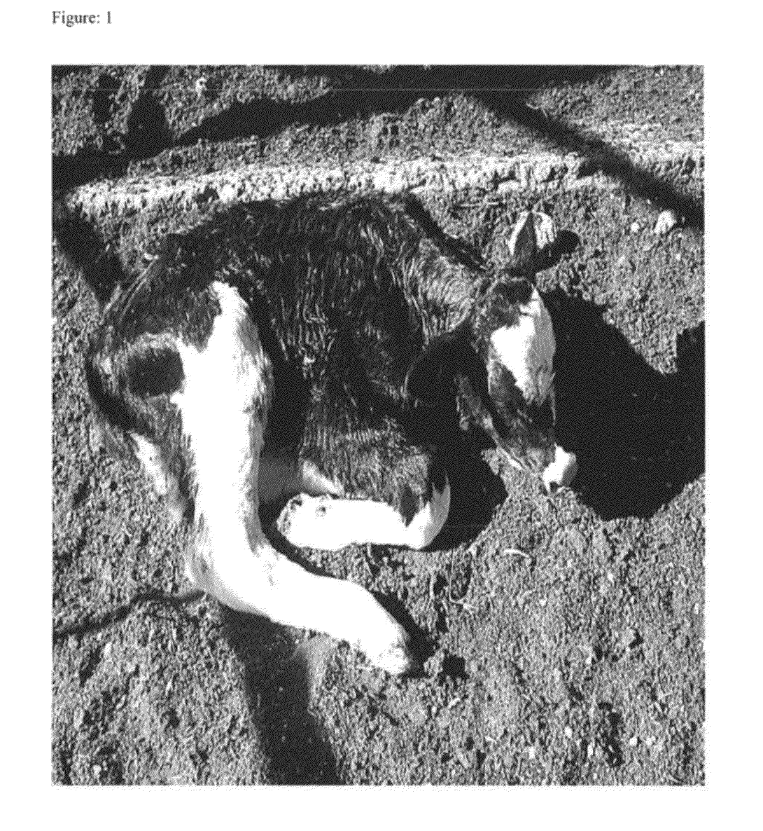

FIG. 2, is a photograph showing calf and hutch.

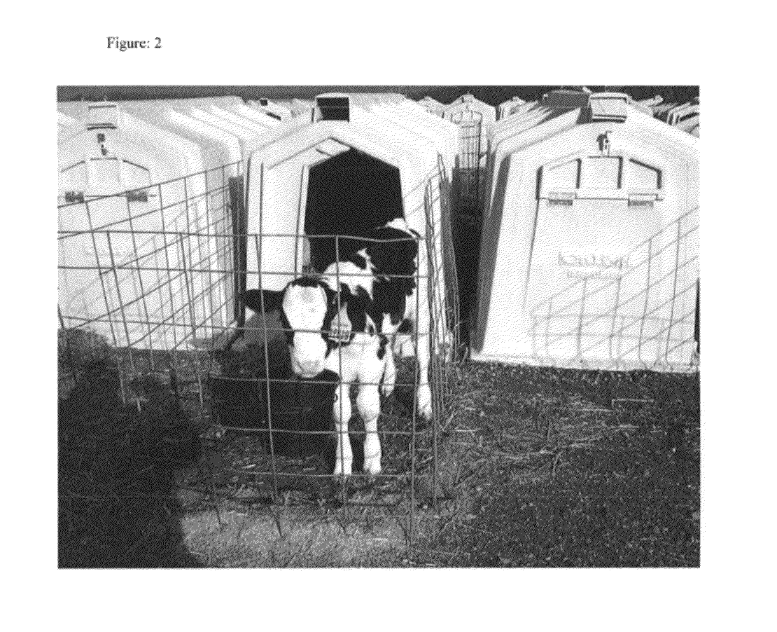

FIG. 3, is a photograph showing calf in its hutch.

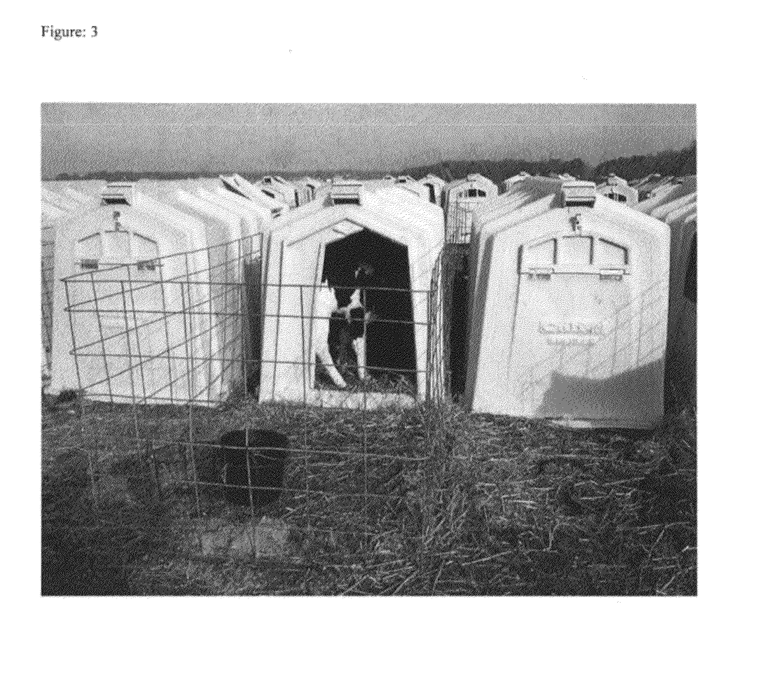

FIG. 4, is a photograph showing a typical calf bedding.

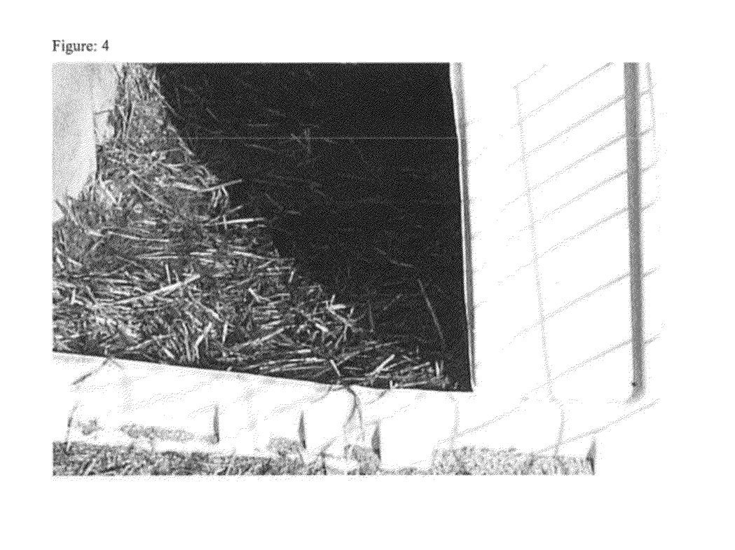

FIG. 5, is a photograph showing group calves and hutches.

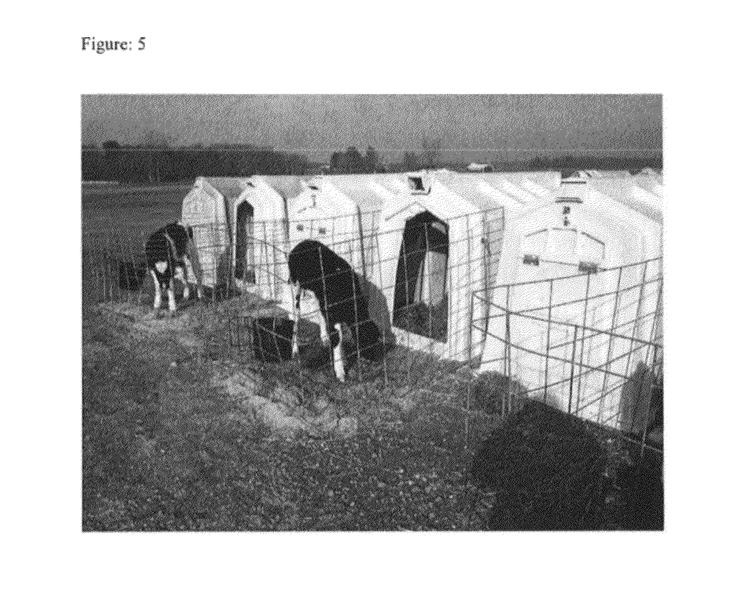

### DESCRIPTION OF THE PREFERRED EMBODIMENTS

### Treatment Compositions

The inventive composition generally includes a biocide system, which includes a primary biocide and a pH buffering component. The primary biocide is selected according to the nature of the microorganisms sought to be controlled, for example, a quaternary ammonium salt. The pH buffer is an electrically-activated acid/salt or base/salt composition that aids in breaking down the cell walls of microorganisms for the delivery of the primary biocide without causing irritation to the skin of the livestock. By way of example, a suitable pH buffer is disclosed in U.S. Pat. No. 7,824,524, which is incorporated by reference herein in its entirety, or in a U.S. patent application Ser. No. 13/346,160, entitled “Reactive, non-corrosive, and dermal-friendly composition and methods for manufacturing” which is also incorporated by reference herein in its entirety and filed contemporaneously with this patent application. The pH buffer is chosen for compatibility with the primary biocide.

Along with the primary biocide, the inventive composition includes a surfactant which helps disperse the biocidal system disperse on the treated surfaces of the pen along with a thickening agent, which helps keep the biocidal system in contact with the treated surfaces of the pen. Further, the inventive composition includes a carrier which helps dissolve the other components and aids in the delivery of the biocidal system. Additionally, the inventive composition may include other substances which do not contribute to its antimicrobial function but add to the usability of the product; for example, the composition may include dyes and fragrances.

### Biocidal System

The disclosed compositions comprise from about 0.05% to about 0.75% by weight of a biocidal system. The biocidal system comprises at least about 75% by weight of a primary biocide primary biocide and at least about 5% by weight of a pH buffering component pH buffer component. The pH buffer is chosen for compatibility with the primary biocide.

### A. Primary Biocide

Suitable biocides include quaternary ammonium compounds chosen from (C12-C14 alkyl) (C1-C2 dialkyl)benzyl ammonium salts, N—(C12-C18 alkyl) heteroaryl ammonium salts, and N—[(C12-C14 alkyl) (C1-C2 dialkyl)] heteroarylalkylene ammonium salts. Non-limiting examples of the (C12-C14 alkyl) (C1-C2 dialkyl)benzyl ammonium salts include (C12-C14 alkyl) dimethyl-benzyl ammonium chloride, (C12-C14 alkyl) dimethylbenzyl ammonium bromide, and (C12-C14 alkyl) dimethylbenzyl ammonium hydrogen sulfate. Non-limiting examples of the N—(C12-C18 alkyl) heteroaryl ammonium salts include cetyl pyridinium chloride, cetyl pyridinium bromide, and cetyl pyridinium hydrogen sulfide. For the N—(C12-C18 alkyl) heteroaryl ammonium salts other anions can be used.

Further examples of quaternary ammonium compounds suitable for use as the primary biocides include cetyltrimethylammonium chloride, stearyltrimethylammonium chloride, isostearyltrimethylammonium chloride, lauryltrimethylammonium chloride, behenyltrimethyl-ammonium chloride, octadecyltrimethylammonium chloride, cocoyltrimethyl ammonium chloride, cetyltrimethylammonium bromide, stearyltrimethylammonium bromide, lauryl-trimethylammonium bromide, isostearyllauryldimethylammonium chloride, dicetyldimethyl-ammonium chloride, distearyldimethylammonium chloride, dicocoyldimethylammonium chloride, gluconamidopropyldimethylhydroxyethylammonium chloride, di-[polyoxyethylene(2)]oleylmethylammonium chloride, dodecyldimethylethylammonium chloride, octyldihydroxyethylmethylammonium chloride, tri[polyoxyethylene(5)]-stearylammonium chloride, polyoxypropylenemethyldiethylammonium chloride, lauryl-dimethyl(ethylbenzyl)ammonium chloride, behenamidopropyl-N,N-dimethyl-N-(2,3-dihydroxypropyl)ammonium chloride, tallowedimethylammoniopropyltrimethylammonium dichloride, and benzalconium chloride.

A second group of suitable biocides includes copper, zinc, silver, salts of chlorides, chlorites, perchlorates, hypochlorates, hypochlorites, sulfates, sulfites, bisulfates and bisulfites. Also, colloid metal such as silver, gold, copper and zinc have superior biocidal properties. Colloidal silver, gold, copper and zinc are extracted and created as ultrafine (0.010-0.001 micron) particles.

A third group of suitable biocides include organic acids which are safe under the FDA GRAS guidelines for food production yet still effective in controlling bacteria. The basic principle action of organic acids on bacteria is that non-dissociated organic acids can penetrate a bacterium cell wall and cause disruption due to the fact it cannot tolerate a wide internal and external pH gradient. With the passive diffusion of organic acids into the bacteria, the acids will dissociate and lower the bacteria's internal pH, leading to an environment that will inhibit or stop the growth of bacteria and viruses. The anionic part of the organic acids that cannot escape the bacteria in its dissociated form will accumulate within the bacteria and disrupt many metabolic functions. This will cause the osmotic pressure inside the cell to increase which state is incompatible with bacterial survival.

The first group of suitable organic acids is Lactic, Acetic, Formic, Fumaric, Citric, Oxalic, Adipic and Uric.

The second group of suitable organic acids is the carboxylic acids, whose acidity is associated with their carboxyl group —COOH. Sulfonic acids, containing the group —SO2OH, are relatively stronger acids. The relative stability of the conjugate base of the acid determines its acidity. In some biological systems more complex organic acids such as L-lactic, citric, and D-glucuronic acids are formed. These use the hydroxyl or carboxyl group.

The third group of suitable organic acids are Humic, Sebacic, Stearic, Gallic, Palmitic, Caffeic, Glyoxylic, Fulvic, Carnosic, Anthranilic, Ellagic, Lipoic, Chlorogenic, Rosmarinic, Phosphoric, Methacrylic, Oleanic, Nitrohumic, Florocinnamic, Hexaflorosilicic, Hydrofluoric, Hydroxycitric and Silicofluoric.

The fourth group of suitable organic acids is fruit acids. The acids in fruits are chiefly acetic, malic, citric, tartaric, oxalic, and in some instances boric. Malic acid is present in apples, pears, currants, blackberries, raspberries, quince, pineapple, cherries, and rhubarb. Citric acid is found in lemons, oranges, grapefruit, lemons, limes, quince, gooseberry, strawberry, raspberry, currant, and cranberry. Tartaric acid occurs in grapes. Boric acid is found in many fresh fruits and vegetables. Mandelic acid is present in almonds.

The fifth group of suitable organic acids is beta hydroxy acids which is a type of phenolic acid. Salicylic acid is a colorless crystalline organic acid whose main active ingredient obtained from this source is a monohydroxiybenzoic acid.

The sixth group of suitable organic acids is a class of products that break biofilm. Biofilms are the protective layer/barrier that surround bacteria. Some species are not able to attach to a surface on their own but are often able to anchor themselves to the matrix or the bacteria cells. It is during this colonization that the cells are able to communicate via its quorum sensing ability. Once colonization has begun, the biofilm grows through a combination of cell division and recruitment. The final stage of biofilm formation is known as development and is the stage in which the biofilm is established and may only change in shape and size. The development of a biofilm may allow an aggregate cell colony to be increasingly resistant. A biofilm's hard protective surface can be broken by Lactobacillus sc Nisin which is produced by fermentation using the bacterium Lactococcus lactis. This is obtained from the culturing of Lactococcus lactis on natural substrates, such as milk or dextrose, and is not chemically synthesized. This is a peptide which is produced by the food grade dairy starter bacterium Lactococcus lactis.

A seventh group of suitable organic acids is natural enzymes. Enzymes are proteins that catalyze chemical reactions and range from just 62 amino acid residues. Typically, these are protease, lipase, diastase and cellulase enzymes. Enzymes are usually very specific as to which reactions they catalyze and the substrates that are involved in these reactions. The shape, charge and hydrophilic/hydrophobic nature characterize the enzymes.

### B. pH Buffer Component

The disclosed composition comprises a pH buffer that is a low pH dermal safe composition with the following range of specifications:
A biocidal, dermal, non-corrosive acid composition, having a maximum proton count of 1.5×10̂25, an embodied conductivity range of from 250 mV to 1500 mV and a 0.1% solution of the composition having a pH of under 2.0.

The pH buffer component of the present invention can be a highly protonated, supercharched, low pH, non-corrosive composition. By way of example, such a composition disclosed in U.S. Pat. No. 7,824,524, which is incorporated by reference herein in its entirety or in a U.S. patent application Ser. No. 13/346,160, entitled “Reactive, non-corrosive, and dermal-friendly composition and methods for manufacturing” which is also incorporated by reference herein in its entirety and filed contemporaneously with this patent application, both of which should be understood to be applicable to the present invention. In addition, other biocidal, dermal, non-corrosive acid compositions could be used providing they have a maximum proton count of 1.5×1025, an embodied conductivity range of from 250 mV to 1500 mV and a 0.1% solution of the composition having a pH of under 2.0.

### C. Surfactant

The disclosed compositions may comprise from about 0.05% to about 5.0% by weight of a cationic surfactant having an hydrophile-lipophile balance (“HLB”) of from about 5 to about 30. One aspect of the disclosed compositions comprises a cationic or ionic surfactant having an HLB of from about 12 to about 18. A further aspect of the disclosed compositions comprises a cationic or ionic surfactant having an HLB of from about 13 to about 16. Another embodiment of the disclosed compositions comprise from about 0.1% to about 4.0% by weight of a cationic or ionic surfactant.

Suitable cationic or ionic surfactants for use in the disclosed compositions include polyoxyethylene C6-C12 alkylphenyl ethers, polyoxyethylene sorbitan tri (C12-C18)-alkanoates, polyoxyethylene sorbitan di (C12-C18)-alkanoates, polyoxyethylene sorbitan mono-, di-, and tri-(C12-C18)-alkanoates, and polyoxyethylene C12-C20 alkyl ethers.

One category of suitable cationic or ionic surfactants for use in the disclosed compositions is the polyoxyethylene C6-C12 alkylphenyl ethers having the formula:

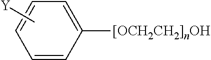

wherein Y is a C6-C12 alkyl unit and n is an index from 5 to 40. Non-limiting examples of C6-C12 alkylphenyl ethers includes polyoxyethylene(5) isooctylphenyl ethers sold under the tradenames IGEPAL™ CA-520 and IGEPAL™ CO-520, polyoxyethylene(8) isooctylphenyl ethers sold under the tradename TRITON™ X-114, polyoxyethylene(9) nonylphenyl ether sold under the tradename IGEPAL™ CO-630, polyoxyethylene(10) isooctylphenyl ether sold under the tradename TRITON™ X-100, polyoxyethylene(branched) nonylphenyl ethers sold under the tradename TRITON™ N-101, polyoxyethylene(12) nonylphenyl ether sold under the tradename IGEPAL™ CO-720, polyoxyethylene(12) isooctylphenyl ether sold under the tradename IGEPAL™ CA-720, polyoxyethylene(40) nonylphenyl ether sold under the tradename IGEPAL™ CO-890, and polyoxyethylene(40) isooctylphenyl ether sold under the trade name TRITON™ X-405.

Another category of cationic or ionic surfactants for use in the disclosed compositions are polyoxyethylene sorbitan mono-, di-, and tri-(C12-C18)-alkanoates, non-limiting examples of which include polyoxyethylene(20) sorbitan trioleate sold under the tradename TWEEN™ 85, polyoxyethylene(20) sorbitan monooleate sold under the tradename TWEEN™ 80, polyoxy-ethylene(20) sorbitan monostearate sold under the tradename TWEEN™ 60, polyoxyethyl-ene(20) sorbitan monopalmitate sold under the tradename TWEEN™ 40, and polyoxyethyl-ene(20) sorbitan monolaurate sold under the trade name TWEEN™ 20.

A further category of cationic or ionic surfactants for use in the disclosed compositions are polyoxyethylene C9-C20 alkyl ethers, non-limiting examples of which include ethoxylate alcohols having the formula:

RO(CH2CH2O)ₘH

wherein R is a linear or branched alkyl group having from 6 to 20 carbon atoms and m is an integer of about 2 to about 20. On example of suitable ethoxylate alcohol surfactants are the NEODOL™ ethoxylated alcohols from Shell Chemicals. Non-limiting examples of suitable ethoxylated alcohols include NEODOL™ 91-5, NEODOL™ 91-6, NEODOL™ 91-8, NEODOL™ 91-9, NEODOL™ 23-6.5, 15 NEODOL™ 25-5, NEODOL™ 25-7, NEODOL™ 25-9, NEODOL™ 25-12, NEODOL™ 45-7, and NEODOL™ 135-7, available from BASF.

### D. Thickening Agent

The disclosed compositions further may comprise from about 0.1% to about 4% by weight of a thickening agent. Suitable thickening agents include hydroxynethyl cellulose, hydroxyethyl cellulose, methylcellulose, hydroxypropyl cellulose, methyl cellulose, carboxy methylcellulose, emulsifying waxes, alkyl triammonium methosulfate, and ceteraryl octanoate. Although the disclosed compositions are aqueous based, certain ingredients may require the presence of a more lipophilic solvent for proper stabilization. Preferred additional solvents are polyhydric alcohol solvents, or “polyol” solvents, such as the polyalkylene glycols having alkylene moieties containing about 2-3 carbon atoms, preferably the polyethylene glycols. Molecular weight ranges of from about 200-4000 are preferred for the polyalkylene glycols (e.g., propylene glycol).

Other examples of thickeners are polysaccharides and linear sulfated polysaccharides of natural origin, which increase the viscosity increase in solution, even at small concentrations. These can be classified as uncharged or ionic polymers natural gums obtained from seaweeds. These are Agar, Alginic acid Sodium alginate, Carrageenan (kappa, Iota or lambda), Gum arabic, Gum ghatti, Gum tragacanth, Karaya gum, Guar gum, Locust bean gum, Beta-glucan, Chicle gum, Dammar gum, Glucomannan, Mastic gum, Psyllium seed husks, Spruce gum, Tara gum Gellan gum and Xanthan gum.

Another example of a suitable thickener poylsaccharides is starch which can be unmodified or modified using acid, enzymes, alkaline, bleached, oxidized, acetylated, hydroxpropylated, octenylsuccinic anhydride, carboxyethylated, phosphate, hydroxypropyl, and acetylated oxidated), cationic, cold water, pregelatinized and instant starch.

One embodiment of the disclosed compositions, utilizes hydroxyethyl cellulose in amounts of 0.5%, 0.6%, 0.7%, 0.8%, 0.9%, and 1% by weight of the composition adjusted for the emollient system and for the final method of applying the composition to the domesticated animal in need of treatment.

In a further embodiment, the thickener can be xanthan gum in amounts of 0.5%, 0.6%, 0.7%, 0.8%, 0.9%, and 1% by weight of the composition adjusted for the emollient system and for the final method of applying the composition to the domesticated animal in need of treatment.

### E. Carriers

The balance of the disclosed compositions may comprise a carrier. The carrier can be any suitable material that can dissolve the active ingredients and co-ingredients and deliver the biocidal system to the infected areas of the animal being treated. Water is a convenient carrier for liquid embodiments of the disclosed composition. However, alcohols can be used to assist in the dissolving of the ingredients prior to dilution with water. Embodiments of the disclosed compositions include gels, sprays, foams and creams, especially for treating cases wherein the infection may be chronic and the animal must be isolated from the rest of the animals and given more intense treatment.

### F. Adjunct Ingredients

The disclosed compositions can further comprise one or more dyes at levels of from about 0.001% to 0.5%. Non-limiting examples of suitable dyes are Alizarine Light Blue B (C.I. 63010), Carta Blue VP (C.I. 24401), Acid Green 2G (C.I. 42085), Astrogen Green D (C.I. 42040), Supranol Cyanine 7B (C.I. 42675, Maxilon Blue 3RL (C.I. Basic Blue 80), Drimarine Blue Z-RL (C.I. Reactive Blue 18), Alizarine Light Blue H-RL (C.I. Acid Blue 182), FD&C Blue No. 1 and FD&C Green No. 3. (See U.S. Pat. No. 4,248,827 and U.S. Pat. No. 4,200,606, both incorporated herein by reference.).

Other colors which can be Lakes that may be used are FD&C Blue No. 1—Brilliant Blue FCF, (blue shade), FD&C Blue No. 2—Indigotine, (dark blue shade), FD&C Green No. 3—Fast Green FCF, (turquoise shade), FD&C Red No. 40—Allura Red AC, (red shade), FD&C Red No. 3—Erythrosine, (pink shade, commonly used in glace cherries), FD&C Yellow No. 5—Tartrazine, (yellow shade), FD&C Yellow No. 6—Sunset Yellow FCF, E110 (orange shade)

Another adjunct ingredient suitable for use in the compositions disclosed herein includes fragrances, for example, fragrances as disclosed in U.S. Pat. No. 6,013,618 included herein by reference in its entirety.

### Example Formulations

The selection and proportions of specific components for the inventive biocidal system will be based on the particular microorganisms to be controlled and the method of delivery, and other factors known to a person of skill in the art and/or easily derived from routine engineering using this disclosure as a guideline. By way of example, Tables I-VI show the selection and proportions of specific components suitable for a biocidal system for use as a bovine pen spray. These compositions are provided as non-limiting examples of effective compositions. The amount of each component is measured in grams.

TABLE I

| Ingredients | 1 | 2 | 3 | 4 | 5 |
|---|---|---|---|---|---|
| cetyl pyridinium chloride | 0.115 | 0.150 | 0.20 | 0.25 | 0.30 |
| pH buffer | 1.0 | 1.0 | 1.0 | 1.0 | 1.0 |
| TRITON X-100 | 0.2 | 0.2 | 0.2 | 0.2 | 0.2 |
| PEG 6 | 1.0 | 1.0 | .10 | 1.0 | 1.0 |
| hydroxyethylcellulose | 0.5 | 0.5 | 0.5 | 0.5 | 0.5 |
| carrier | balance | balance | balance | balance | balance |
| Adjunct Ingredients | trace | trace | trace | trace | trace |

TABLE II

| Ingredients | 6 | 7 | 8 | 9 | 10 |
|---|---|---|---|---|---|
| cetyl pyridinium chloride | 0.40 | 0.50 | 0.35 | 0.35 | 0.35 |
| pH buffer | 1.0 | 1.0 | 1.0 | 1.0 | 1.0 |
| PEG 6 | 1.0 | 1.0 | 1.0 | 1.0 | 1.0 |
| TRITON X-100 | 0.2 | 0.2 | 0.2 | 0.2 | 0.2 |
| hydroxyethylcellulose | 0.5 | 0.5 | 0.5 | 0.5 | 0.5 |
| carrier | balance | balance | balance | balance | balance |
| Adjunct Ingredients | trace | trace | trace | trace | trace |

TABLE III

| Ingredients | 11 | 12 | 13 | 14 | 15 |
|---|---|---|---|---|---|
| cetyl pyridinium chloride | 0.35 | 0..35 | 0.35 | 0..35 | 0..35 |
| pH buffer | 1.0 | 1.0 | 1.0 | 1.0 | 1.0 |
| PEG 6 | 1.0 | 1.0 | 1.0 | 1.0 | 1.0 |
| TRITON X-100 | 0.2 | 0.2 | 0.2 | 0.2 | 0.2 |
| hydroxyethylcellulose | 0.5 | 0.5 | 0.5 | 0.5 | 0.5 |
| carrier | balance | balance | balance | balance | balance |
| Adjunct Ingredients | trace | trace | trace | trace | trace |
| carrier | balance | balance | balance | balance | balance |

TABLE IV

| Ingredients | 16 | 17 | 18 | 19 | 20 |
|---|---|---|---|---|---|
| cetyl pyridinium chloride | 0.135 | 0.130 | 0.125 | 0.12 | 0.115 |
| pH buffer | | | | | |
| TRITON X-100 | 0.2 | 0.2 | 0.2 | 0.2 | 0.2 |
| PEG 6 | 1.0 | 1.0 | 1.0 | 1.0 | 1.0 |
| hydroxyethylcellulose | 0.1 | 0.25 | 0.4 | 0.75 | 1.0 |
| carrier | balance | balance | balance | balance | balance |
| Adjunct Ingredients | trace | trace | trace | trace | trace |

TABLE V

| Ingredients | 21 | 22 | 23 | 24 | 25 |
|---|---|---|---|---|---|
| (C₁₂-C₁₄ alkyl)- | 0.135 | 0.130 | 0.125 | 0.12 | 0.115 |
| dimethylbenzyl | | | | | |
| ammonium chloride | | | | | |
| pH buffer | 1.0 | 1.0 | 1.0 | 1.0 | 1.0 |
| TRITON X-100 | 0.2 | 0.2 | 0.2 | 0.2 | 0.2 |
| Xanthan gum | 0.5 | 0.6 | 0.7 | 0.8 | 0.9 |
| carrier | balance | balance | balance | balance | balance |
| Adjunct Ingredients | trace | trace | trace | trace | trace |

TABLE VI

| Ingredients | 26 | 27 | 28 | 29 | 30 |
|---|---|---|---|---|---|
| cetyl pyridinium chloride | 0.135 | 0.130 | 0.125 | 0.12 | 0.115 |
| pH buffer | 1.0 | 1.0 | 1.0 | 1.0 | 1.0 |
| TRITON N-101 | 0.2 | 0.2 | 0.2 | 0.2 | 0.2 |
| Xanthan gum | 1.0 | 1.0 | 1.0 | 1.0 | 1.0 |
| carrier | balance | balance | balance | balance | balance |
| Adjunct Ingredients | trace | trace | trace | trace | trace |

### Methods of Use

The disclosed compositions can be used for various applications with the application route and dosage regimen dictated by the amount of bacteria, viruses or parasites present. As an example of possible applications of the invention, the compositions can be used on bedding, pens, hutches, its surroundings and on animals and/or stemming from microbial infections. The composition can be applied as a cleanser, scrub (cleanser with abrasive properties), spray, foam, lotion, or gel.

### EXAMPLES

The following procedures can be used to evaluate the disclosed compositions against various microorganisms. The results below further indicate the effectiveness of the disclosed compositions. Bacterial tests were completed at Biological Consulting Services of North Florida, Inc. on the following strains: E. coli (ATCC 15597), Salmonella enterica (ATCC BAA-711), Methicillin Resistant Staphylococcus aureus (MRSA; BAA-44) and Staphylococcus aureus ATCC #6538. The results are documented in Table A.

TABLE A

| Sample | Control units (cfu/ml) | Results units (cfu/ml) |
|---|---|---|
| E. coli | 9.3 × 10\hat{ }5 | <0.5 |
| S. enterica | 1.1 × 10\hat{ }6 | <0.5 |
| MRSA | 1.0 × 10\hat{ }6 | <0.5 |
| Staphylococcus aureus | 7.9 × 10\hat{ }7 cfu/ml | 2.5 cfu/ml |

*cfu—colony forming units

Viral tests were completed at Biological Consulting Services of North Florida, Inc. on the following on the following Orthomyxviridie virus ATCC type CCL-34, Influenza A/Equi 2(ATCC VR517) Poliovirus 1 (Chat; ATCC VR-1562), and Rhinovirus 39 (ATCC VR-340). The results are documented in Table B.

TABLE B

| Sample | Control units | Results units |
|---|---|---|
| Orthomyxviridie virus | 6.2 × 10\hat{ }6 | <200 cfu/ml |
| Influenza A (H1N1) | 3.1 × 10\hat{ }4 | <200 cfu/ml |
| Poliovirus 1 | 1.6 × 10\hat{ }5 | 2.1 × 10\hat{ }1 |
| Rhinovirus 39 | 6.7 × 10\hat{ }5 | <200 cfu/ml |

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A composition for controlling or preventing bacteria, viruses and parasitic growths that causes diarrhea, pneumonia and septicemia in animals comprising:
a) from about 0.05% to about 0.75% by weight of a biocidal system, comprising:
i) at least about 75% by weight of a primary biocide; and
ii) at least about 25% by weight of a pH buffer component.

2. The composition of claim 1 further comprising from about 0.05% to about 0.2% by weight of a cationic or ionic surfactant having an HLB of from about 5 to about 30.

3. The composition of claim 1 further comprising from about 0.1% to about 4% by weight of a thickening agent.

4. The composition of claim 1 further comprising an aqueous based carrier.

5. The composition according to claim 1, wherein the primary biocide is a quaternary ammonium salt comprising at least one aryl or heteroaryl unit.

6. The composition according to claim 1, wherein the primary biocide is chosen from (C12-C14 alkyl)(C1-C2 dialkyl)benzyl ammonium salts, N—(C12-C18 alkyl)heteroaryl ammonium salts, and N—[(C12-C14 alkyl)(C1-C2 dialkyl)]heteroarylalkylene ammonium salts.

7. The composition according to claim 1, wherein the primary biocide is chosen from (C12-C14 alkyl)dimethylbenzyl ammonium chloride, (C12-C14 alkyl)dimethylbenzyl ammonium bromide, (C12-C14 alkyl)dimethylbenzyl ammonium hydrogen sulfate, cetyl pyridinium bromide, and cetyl pyridinium hydrogen sulfide.

8. The composition according to claim 1, wherein the primary biocide is cetyl pyridinium chloride.

9. The composition according to claim 1, wherein the biocidal system comprises:
i) from about 75% to about 95% by weight of a primary biocide; and
ii) from about 5% to about 25% by weight of a pH buffer component.

10. The composition according to claim 1, wherein the biocidal system comprises:
i) from about 75% to about 95% by weight of cetyl pyridinium chloride; and
ii) from about 5% to about 25% by weight of pH buffer component.

11. The composition according to claim 1, wherein the primary biocide is chosen from copper, zinc, silver, salts of chlorides, chlorites, perchlorates, hypochlorites, sulfates sulfites, nitrates, nitrites and hydroxides.

12. The composition according to claim 1, wherein the primary biocide is chosen from several fruit acids such as acetic, malic, citric, tartaric, oxalic, tartaric, mandelic and boric.

13. The composition according to claim 1, wherein the primary biocide is chosen from several organic acids such as Lactic, Acetic, Formic, Fumaric, Adipic, Citric, Oxalic, or Uric.

14. The composition according to claim 1, wherein the primary biocide is chosen from several organic acids containing carboxylic and/or Sulfonic acids such as Humic, Sebacic, Stearic, Gallic, Palmitic, Caffeic, Glyoxylic, Fulvic, Carnosic, Anthranilic, Ellagic, Oleanic, Lipoic, Chlorogenic, Rosmarinic, Phosphoric, Methacrylic, Nitrohumic, Florocinnamic, Hexaflorosilicic, Hydrofluoric, Hydroxycitric and Silicofluoric.

15. The composition according to claim 1, wherein the primary biocide is chosen from suitable organic acids that are beta hydroxy acids such Salicylic acid.

16. The composition according to claim 1, wherein the primary biocide is chosen from natural and/or organic acids that break biofilm.

17. The composition according to claim 1, wherein the primary biocide is chosen from a wide range of natural enzymes such as proteolytic, amylolytic, cellulase, papin, invertase, lipolytic, pepsin, bromelain and lactase.

18. The composition according to claim 1, wherein the pH buffer system comprises a low pH dermal safe composition with the following range of specifications:
i) A biocidal, dermal, non-corrosive acid composition, having a maximum proton count of 1.5×10̂25, an embodied conductivity range of from 250 mV to 1500 mV and a 0.1% solution of the composition having a pH of under 2.0.

19. The composition according to claim 2, wherein the surfactant is chosen from a polyoxyethylene C6-C12 alkylphenyl ether, polyoxyethylene sorbitan tri(C12-C18)-alkanoate, polyoxyethylene sorbitan di(C12-C18)-alkanoate, polyoxyethylene sorbitan mono(C12-C18)-alkanoate, or polyoxyethylene C9-C20 alkyl ether.

20. The composition according to claim 2, wherein the surfactant is a polyoxyethylene C6-C12 alkylphenyl ether having from about 8 to about 12 ethyleneoxy units.

21. The composition according to claim 2 wherein the cationic or ionic surfactant is a polyoxyethylene(5) isooctylphenyl ether, polyoxyethylene(8) isooctylphenyl ether, polyoxyethylene(9) nonylphenyl ether, polyoxyethylene(10) isooctylphenyl ether, polyoxyethylene(branched) nonylphenyl ether, polyoxyethylene(12) nonylphenyl ether, polyoxyethylene(12) isooctylphenyl ether, polyoxyethylene(40) nonylphenyl ether, and polyoxyethylene(40) isooctylphenyl ether.

22. The composition according to claim 2, wherein the cationic or ionic surfactant is polyethylene glycol 4-(1,1,3,3-tetramethylbutyl)phenyl ether.

23. The composition according to claim 2, wherein the cationic or ionic surfactant is a polyoxyethylene sorbitan mono-, di-, and tri-(C12-C18)-alkanoate.

24. The composition according to claim 2, wherein the cationic or ionic surfactant is a polyoxyethylene(20) sorbitan trioleate, polyoxyethylene(20) sorbitan monooleate, polyoxyethylene(20) sorbitan monostearate, polyoxyethylene(20) sorbitan monopalmitate, and polyoxyethylene(20) sorbitan monolaurate.

25. The composition according to claim 2, wherein the cationic or ionic surfactant is a polyoxyethylene C9-C20 alkyl ether.

26. The composition according to claim 2, wherein the cationic or ionic surfactant is a polyoxyethylene C9-C20 alkyl ether chosen from C9-C11 alkyl-(5)-ethoxylate, C9-C11 alkyl-(6)-ethoxylate, C9-C11 alkyl-(8)-ethoxylate, C9-C11 alkyl-(9)-ethoxylate, C2-C13 alkyl-(6.5)-ethoxylate, C12-C15 alkyl-(5)-ethoxylate, C12-C15 alkyl-(7)-ethoxylate, C12-C15 alkyl-(9)-ethoxylate, C12-C15 alkyl-(12)-ethoxylate, C14-C15 alkyl-(7)-ethoxylate, and C11-C15 alkyl-(7)-ethoxylate.

27. The composition according to claim 2, wherein the cationic or ionic surfactant has an HLB of from about 12 to about 18.

28. The composition according to claim 2, wherein the cationic or ionic surfactant has an HLB of from about 13 to about 16.

29. The composition according to claim 3, wherein the thickening agent is chosen from hydroxynethyl cellulose, hydroxyethyl cellulose, methylcellulose, hydroxypropyl cellulose, methyl cellulose, carboxy methylcellulose, emulsifying waxes, alkyl triammonium methosulfate, and ceteraryl octanoate.

30. The composition according to claim 3, wherein the thickening agent is hydroxyethyl cellulose.

31. The composition according to claim 3, wherein the thickening agent is chosen from, polysaccharides, linear sulfated polysaccharides.

32. The composition according to claim 3, wherein the thickening agent is polysaccharides and linear sulfated polysaccharides of natural origin.

33. The composition according to claim 3, wherein the thickening agent is chosen from, polysaccharides, linear sulfated polysaccharides to be xanthan gum.

34. The composition according to claim 3, wherein the thickening agent poylsaccharides is starch which can be unmodified or modified using acid, enzymes, alkaline, bleached, oxidized, acetylated, hydroxpropylated, octenylsuccinic anhydride, carboxyethylated, phosphate, hydroxypropyl, and acetylated oxidated), cationic, cold water, pregelatinized and instant starch.

35. A composition for controlling or preventing bacteria, viruses and parasitic growths that causes diarrhea, pneumonia and septicemia in animals, that composition comprising:
a) about 1.5% by weight of a biocidal system, comprising:
i) 90% by weight of cetyl pyridinium chloride; and
ii) 10% by weight of pH buffer;
b) about 0.2% by weight of polyoxyethylene(10) isooctylphenyl ether; and
c) about 0.5% by weight of hydroxyethylcellulose; and
d) the balance an aqueous based carrier.

36. A composition for controlling or preventing bacteria, viruses and parasitic growths that causes diarrhea, pneumonia and septicemia in animals, that composition comprising:
a) from about 0.05% to about 0.75% by weight of a biocidal system, comprising:
i) at least about 75% by weight of a primary biocide; and
ii) at least about 25% by weight of a pH buffer component;
b) from about 0.05% to about 0.2% by weight of a cationic or ionic surfactant having an HLB of from about 5 to about 30; and
c) from about 0.1% to about 1% by weight of a thickening agent; and
d) the balance an aqueous based carrier.

37. A composition for controlling or preventing bacteria, viruses and parasitic growths that causes diarrhea, pneumonia and septicemia in animals, that composition comprising:
a) from about 0.05% to about 0.75% by weight of a biocidal system, comprising:
i) from about 75% to about 95% by weight of a primary biocide; and
ii) from about 5% to about 25% by weight of a pH buffet component;
b) from about 0.05% to about 0.2% by weight of a cationic or ionic surfactant having an HLB of from about 13 to about 16; and
c) from about 0.25% to about 0.75% by weight of a thickening agent; and
d) the balance an aqueous based carrier.

38. A composition for controlling or preventing bacteria, viruses and parasitic growths that causes diarrhea, pneumonia and septicemia in animals, that composition comprising:
a) about 1.5% by weight of a biocidal system, comprising:
i) 80% by weight of cetyl ammonium chloride;
ii) 20% by weight of a pH buffer component and
b) about 0.2% by weight of polyoxyethylene(10) isooctylphenyl ether; and
c) about 0.5% by weight of xanthan gum; and
d) the balance an aqueous based carrier.

39. A composition for controlling or preventing bacteria, viruses and parasitic growths that causes diarrhea, pneumonia and septicemia in animals, that composition comprising:
a) from about 0.05% to about 1.50% by weight of a biocidal system, comprising:
i) at least about 75% by weight of a primary biocide; and
ii) at least about 25% by weight of a pH buffer component;
b) from about 0.05% to about 0.2% by weight of a cationic or ionic surfactant having an HLB of from about 5 to about 30; and
c) from about 0.1% to about 1% by weight of a thickening agent; and
d) the balance an aqueous based carrier.

40. A composition for controlling or preventing bacteria, viruses and parasitic growths that causes diarrhea, pneumonia and septicemia in animals, that composition comprising:
a) from about 0.05% to about 0.75% by weight of a biocidal system, comprising:
i) from about 75% to about 95% by weight of a primary biocide; and
ii) from about 5% to about 25% by weight of a pH buffer component;
b) from about 0.05% to about 0.2% by weight of a nonionic surfactant having an HLB of from about 13 to about 16; and
c) from about 0.05% to about 0.75% by weight of a thickening agent; and
d) the balance an aqueous based carrier.

41. A composition for controlling or preventing bacteria, viruses and parasitic growths that causes diarrhea, pneumonia and septicemia in animals, that composition comprising:
a) about 1.5% by weight of a biocidal system, comprising:
i) 90% by weight of cetyl pyridinium chloride; and
ii) 10% by weight of pH buffer;
b) about 0.2% by weight of polyoxyethylene(10) isooctylphenyl ether; and
c) about 0.5% by weight of xanthan gum; and
d) the balance an aqueous based carrier.

42. A method of controlling or preventing bacteria, viruses and parasitic growths that causes diarrhea, pneumonia and septicemia in animals comprising:
applying a composition comprising from about 0.05% to about 0.75% by weight of a biocidal system;
wherein said biocidal system comprising at least about 75% by weight of a primary biocide; and at least about 5% by weight of a pH buffer component to an animal's surroundings.

43. The method of claim 42 wherein the composition is applied as a cleanser.

44. The method of claim 42 wherein the composition is applied as a scrub.

45. The method of claim 42 wherein the composition is applied as a spray.

46. The method of claim 42 wherein the composition is applied as a foam.

47. The method of claim 42 wherein the composition is applied as a gel.
